(19) United States
(12) Patent Application Publication
(10) Pub. No.: US 2003/0139917 A1
(43) Pub. Date: Jul. 24, 2003

(54) Late binding of resource allocation in a performance simulation infrastructure

(75) Inventors: Jonathan Christopher Hardwick, Cambridge (GB); Efstathios Papaefstahiou, Cambridge (GB)

Correspondence Address: LEE & HAYES PLLC, 421 W RIVERSIDE AVENUE SUITE 500, SPOKANE, WA, 99201

(73) Assignee: Microsoft Corporation

(21) Appl. No.: 10/053,733

(22) Filed: Jan. 18, 2002

(51) Int. Cl. G06F 9/44; G06F 13/10; G06F 13/12; G06F 9/45

(52) U.S. Cl. 703/21

(57) ABSTRACT

A performance simulation infrastructure for predicting the performance of software systems separates the workload definition and performance evaluation components of the simulation into separate and distinct stages. Workload definitions are generated in the first stage as a sequence of associated resource usage requests (or “workload requests”). In a second stage, an evaluation engine receives the workload definition sequence and simulates the system performance, without continuously looping back to the workload definition generator for a new state of the workload. Scheduling simulation of request events to appropriate hardware models is deferred until the evaluation stage, thereby simplifying the workload definition operation.

### RELATED APPLICATIONS

The application is related to U.S. patent application Ser. No. ______, entitled “EVALUATING HARDWARE MODELS HAVING RESOURCE CONTENTION” [Docket No. MS#183174.1/40062.164US01], specifically incorporated herein for all that it discloses and teaches.

### TECHNICAL FIELD

The invention relates generally to computer system performance simulation, and more particularly to a performance simulation infrastructure allowing separate stages of workload definition and evaluation.

### BACKGROUND OF THE INVENTION

Performance simulation of software systems running on one or more computers is a crucial consideration for developers deploying network-based services, such as those services available over the Internet, an intranet, or an extranet. For example, developers often want to determine how their software design decisions will affect future system performance. Likewise, system users want to determine the optimal mix of hardware to purchase for an expected system load level, and system administrators want to identify the bottlenecks in their system and the system load levels at which to expect performance problems.

During the design of such software services, a software developer may employ performance simulation tools to simulate the software system prior to release, in hope of finding an optimal design and to identify and troubleshoot potential problems. With such preparation in the design and implementation phases of the software systems, the developer stands an improved probability of maintaining the necessary system performance demanded by users under a variety of conditions. However, many developers merely use ad-hoc or custom performance simulation techniques based on simple linear regression models. More sophisticated and more accurate approaches are desirable.

Predicting system performance under a wide variety of conditions is a difficult task that requires understanding of the complex nature of the software and hardware used in the system. A limited set of tools and techniques are currently available for modeling realistic workloads. Software performance engineering is also an emerging discipline that incorporates performance studies into software development. For example, performance specification languages provide formalism for defining software behavior at various levels of abstraction. The performance specification languages can be used to prototype the performance of a software application or to represent the performance characteristics of the source code in detail.

However, performance simulation of such software systems, despite its substantial value to successful design and development of net-based service software, has not been widely integrated into the development processes of such systems. One possible reason is the amount of resources consumed in modeling the software. Another possible factor is the limited applicability of the developed models to the great variety of real world conditions. Because of the cost of developing models, only a few generic models are available. These generic models are generally used to model a variety of software systems but are typically not flexible enough to accurately model a specific prototype application within an arbitrary resource configuration (e.g., hardware configuration). Furthermore, custom developed models and tools are even more costly and difficult to develop and use.

One aspect contributing to the expense and difficulty in using existing performance simulation solutions is that existing solutions integrate the definition of system workload with the evaluation of system performance. That is, for each state in the system, the performance simulation tool loops or iterates between generating a workload definition for the next state of the software system and simulating the performance for that state. This incremental architecture introduces considerably complexity to the task of writing new workload definitions because the workload generator must interface with the simulator at each incremental simulation interval. In addition, the integration of workload definition and evaluation operations of existing approaches substantially precludes the effective encapsulation of core modeling functionality into a common performance simulation infrastructure. A flexible and easily customizable performance simulation infrastructure is not available in prior approaches, in part because of the iterative processing of the workload definition and evaluation operations at each simulation interval.

### SUMMARY OF THE INVENTION

Embodiments of the present invention solve the discussed problems by providing a performance simulation infrastructure that separates the workload definition and performance evaluation components of the simulation into separate and distinct stages. Workload definitions are generated in the first stage as a sequence of associated resource usage requests (or “workload requests”). In a second stage, an evaluation engine receives the workload definition sequence and simulates the system performance, without continuously looping back to the workload definition generator for a new state of the workload. Scheduling simulation of request events to appropriate hardware models is deferred until the evaluation stage, thereby simplifying the workload definition operation.

In implementations of the present invention, articles of manufacture are provided as computer program products. One embodiment of a computer program product provides a computer program storage medium readable by a computer system and encoding a computer program that simulates performance of a software system including one or more resources. Another embodiment of a computer program product may be provided in a computer data signal embodied in a carrier wave by a computing system and encoding the computer program that simulates performance of a software system including one or more resources.

The computer program product encodes a computer program for executing on a computer system a computer process for simulating performance of a software system including one or more resources is provided. One or more workload definition sequences defining the software system are generated. Each workload definition sequence includes a plurality of workload request nodes, at least two of which have a sequential relationship relative to different simulation intervals. The workload definition sequence is received into an evaluation engine. The one or more workload definition sequences are evaluated to simulate the performance of the software system.

In another implementation of the present invention, a method of simulating performance of a software system including one or more resources is provided. One or more workload definition sequences defining the software system are generated. Each workload definition sequence includes a plurality of workload request nodes, at least two of which have a sequential relationship relative to different simulation intervals. The workload definition sequence is received into an evaluation engine. The one or more workload definition sequences are evaluated to simulate the performance of the software system.

In yet another embodiment of the present invention, a performance simulation system that simulates performance of a software system is provided. A workload generator generates one or more workload definition sequences defining the software system. Each workload definition sequence includes a plurality of workload request nodes including at least two of which have a sequential relationship relative to different simulation intervals. An evaluation engine receives the one or more workload simulation sequences and evaluates the one or more workload definition sequences to simulate the performance of the software system.

These and various other features as well as other advantages, which characterize the present invention, will be apparent from a reading of the following detailed description and a review of the associated drawings.

### BRIEF DESCRIPTION OF THE DRAWINGS

FIG. 1 illustrates two stages of a performance simulation flow and associated data stores in an embodiment of the present invention.

FIG. 2 illustrates an exemplary sequence of requests associated with a query request to an application in an embodiment of the present invention.

FIG. 3 illustrates nodes in a representation of an exemplary workload definition sequence associated with the requests depicted in FIG. 2 in an embodiment of the present invention.

FIG. 4 illustrates an evaluation engine for simulating performance of a software system in an embodiment of the present invention.

FIG. 5 illustrates operations for performing a performance simulation in an embodiment of the present invention.

FIG. 6 illustrates operations for evaluating a software system in an embodiment of the present invention.

FIG. 7 illustrates an exemplary system useful for implementing an embodiment of the present invention.

FIG. 8 depicts exemplary simulation results in an embodiment of the present invention.

FIG. 9 shows a screen shot depicting graphical representations of workload definition sequences in an embodiment.

### DETAILED DESCRIPTION OF THE INVENTION

During development of a net-based service application, it is beneficial to simulate the operation of the application within a model of the overall system in which it is expected to execute (collectively referred to as the “software system”). For example, an e-commerce retail application that allows consumers to shop for a company's products over the Internet will operate in a system including various web servers, routers, communication links, database servers, clients, etc. Simulation of the software system allows a developer to understand how his or her design decisions impact the software system's performance in real-world conditions. Simulation of the software system can also assist a system user in making hardware purchase and system architecture decisions and assist a system administrator to identify bottlenecks and to anticipate performance problems at given load levels.

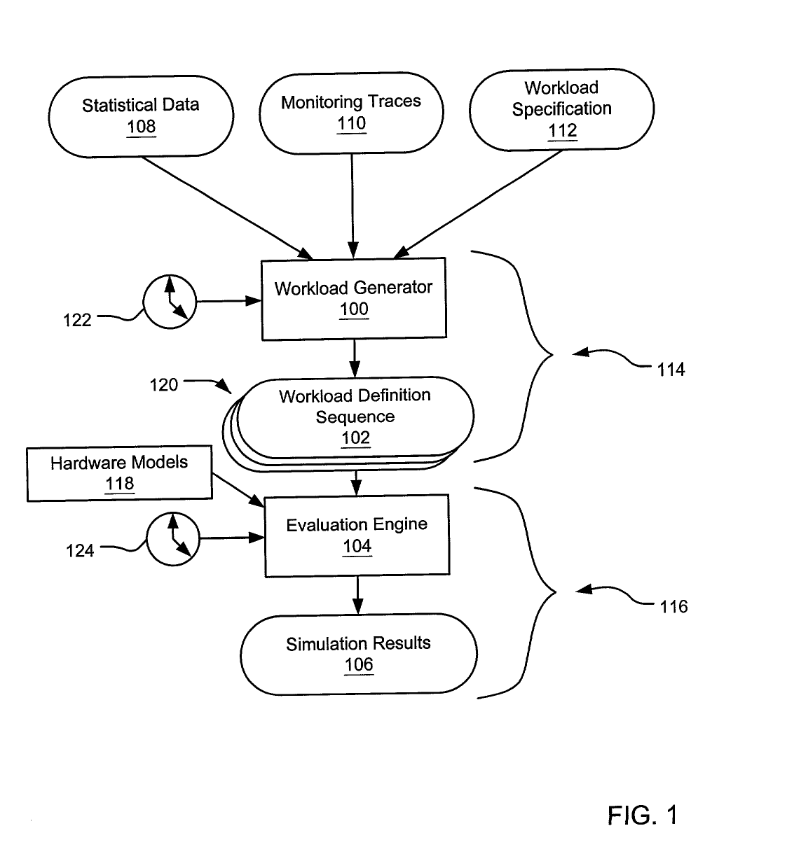

FIG. 1 illustrates two stages of a performance simulation flow and associated data in an embodiment of the present invention. A workload generator 100 receives one or more inputs to generate one or more workload definition sequences 120 (also called Workload Request Timelines or WRTs), which characterize a sequence of requests that affect the status of the system being simulated. The workload generator 100 may receive the inputs individually or in any combination or sequence.

The term “sequence” implies that at least two workload requests within a workload definition sequence have a sequential relationship relative to different simulation intervals. For example, in one embodiment, one request is defined as completing evaluation in one simulation interval and another request is defined as beginning evaluation in an ensuing simulation interval. A workload definition sequence represents a series of workload requests that represents logical workload units. For example, a transaction with a database or an e-commerce site can be defined as a workload definition sequence. Each workload request in a workload definition sequence defines one or more events, the cause of each event, the result of each event (e.g., event causality), and other parameters (e.g., cost in terms of CPU cycles, bandwidth, and storage). Events are tagged with the type of device that can handle the event and a run-time policy (e.g., a scheduling policy) defining how to choose among available resources of the appropriate type.

A clock 122, or some other means of determining time-dependence or interrelation among the various workload definition sequences 120, may be used to set an initiation parameter (e.g., a start time) on a start node in one or more of the workload definition sequences 120. An evaluation engine 104 receives the one or more workload definition sequences 120 and generates simulation results 106, which include the simulated times required for the software system to complete each workload request. In other words, the evaluation engine 104 calculates the predicted duration of each component event of the requests in the system to predict system performance.

The workload generator 100 creates a workload definition sequence 102 in the first stage of simulation, i.e., the workload definition stage 114. The workload definition sequence 102 is then input to the evaluation engine 104 in an evaluation stage 116, which can complete the simulation without requesting any additional workload generation operation from the workload generator 100.

The workload definition sequence 102 defines sequentially related workload requests representing real-world transactions. A workload request is represented by a workload request node in a workload definition sequence. Using control flow nodes, a workload definition sequence may be forked and rejoined (e.g., representing the spawning and killing of process threads). In one embodiment, a workload definition sequence 102 is triggered at a specific instant of time (e.g., relative to a simulation clock 124) and terminates when the last request is processed. The trigger time is also referred to as a start time.

The workload definition sequence 102 may include without limitation one of the following types of exemplary nodes:

(1) a workload request node—a description node specifying a type of request and its characteristics;

(2) a fork node—a control flow construct specifying the spawning of a new thread (i.e., the splitting of a workload request node sequence portion into multiple sequences portions);

(3) a join node—a control flow construct specifying the termination of a thread (i.e., the joining of separate workload request node sequence portions into a single sequence portion); and

(4) a start node—a control flow construct initiating a workflow definition sequence (e.g., a start of a new transaction).

Fork nodes, join nodes and start nodes represent control flow constructs from which the evaluation engine determines the defined relationships among workload request nodes. A fork node specifies a “previous” node and a plurality of “next” nodes, thereby splitting a single workload request node sequence portion into multiple sequence portions. A join node specifies a plurality of “previous” nodes and a single “next” node, thereby joining multiple workload request node sequence portions into a single sequence portion. A start node specifies a start time and a “next” node. It should be understood that the nodes specified by the control flow nodes may be other control flow nodes or workload request nodes.

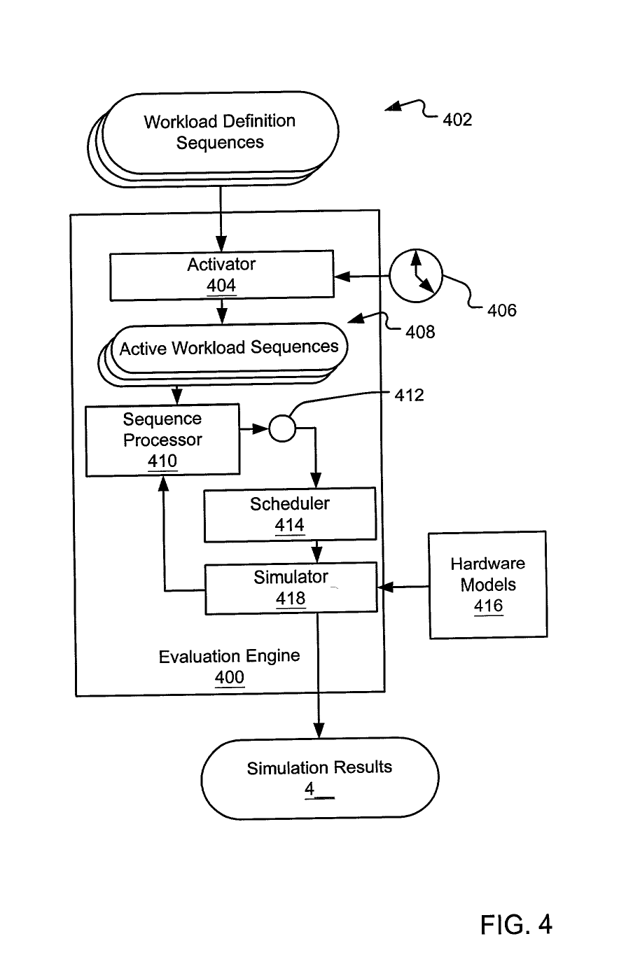

As discussed, a fork node can split a single workload request node sequence portion into two concurrently processing sequence portions, such as two multitasking threads in an application. Without the fork node, a single sequence processes each workload request node to completion before proceeding to the next available workload request node. Concurrent processing allows one sequence portion, upon completion of processing of one workload request node, to proceed to a next workload request node in that portion, independent of completion of a currently processing workload request node in the other sequence portion. The interdependence and independence of workload request node processing will be further described with regard to the translation of requests into component events and the sequence processor in FIG. 4.

Likewise, a join node can bring together two concurrently processing sequence portions into a single workload request node sequence portion. As such, two concurrently processing sequences, in which completed request nodes in each workload request node sequence portion can proceed to the next request node in that sequence portion without waiting for completion of any request node in the other sequence portion, can re-establish the sequential dependence of workload request nodes in a workload definition sequence.

A workload request node specifies a “previous” node, a “next” node, the type of request (e.g., compute, send, etc.), one or more resources associated with the request (e.g., the cost in CPU cycles, communication bandwidth, or storage), and other parameters useful in describing the request (e.g., from a client, to a web server). Each workload request node can also be associated with a device option that characterizes constraints on how a request and/or its component events may be assigned to one of the resources in the software system. Exemplary device options may include without limitation:

(1) Use a scheduler to assign the request to a specific resource;

(2) Use a scheduler to assign the request to a specific resource and mark the selected resource for future use;

(3) Use an event list (e.g., a previously generated schedule of event assignments to resources); and

(4) Use a previously marked scheduled resource.

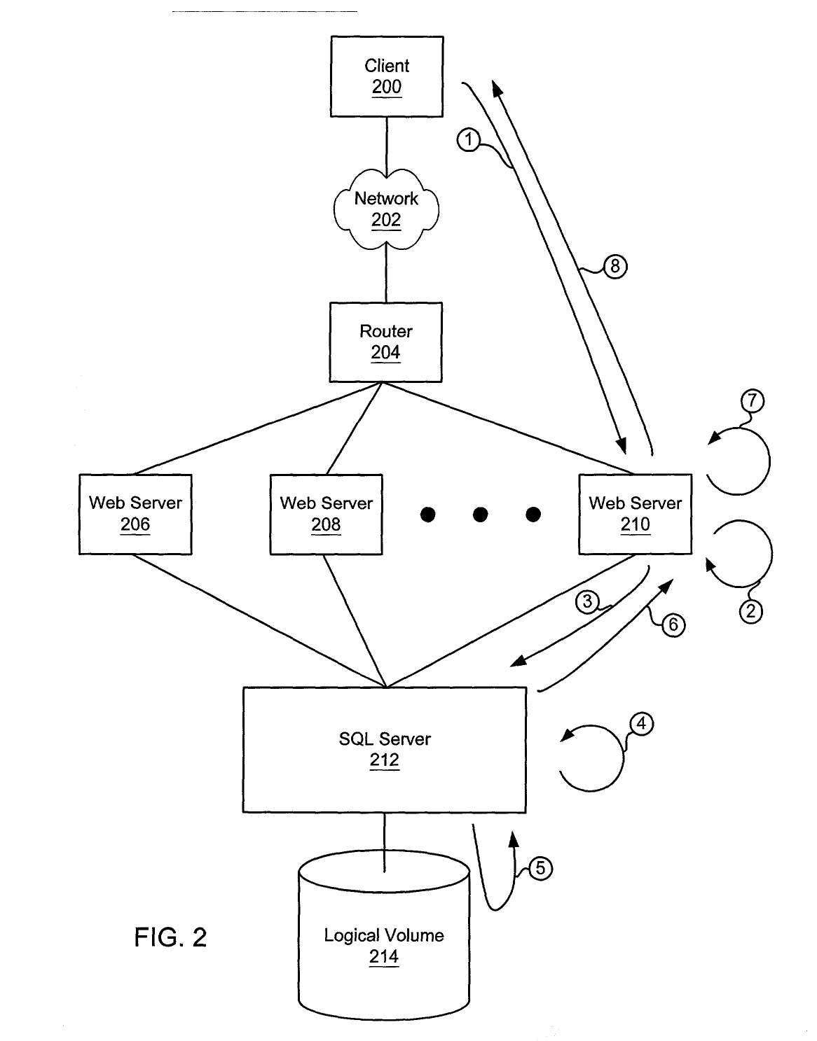

The device option (1), specifying that a scheduler assigns the request to a specific resource, indicates that the scheduler is to assign the request to a specific resource, either specifically identified resource (e.g., SQL server 212 of FIG. 2) or a resource identified by application of a scheduling policy (e.g., one of Web servers 206-210).

The device option (2), specifying that the scheduler is to assign the request to a specific resource and mark the selected resource for future use, indicates that the scheduler is to assign the request node in accordance with device option (1) and to further associate the workload definition sequence with that specific resource. By doing so, a subsequent workload request node in that workload definition sequence may be assigned using device option (4) to the same resource, such as on the return path of the request node sequence illustrated in FIG. 2. In the illustration of FIG. 2, a Request No. 6 returns to the same Web server 210 that originated Request No. 3, as would typically occur in actual operation of the software system. Accordingly, the Request No. 1 would be associated with Web server 210 using device option (2). Thereafter, Request Nos. 2, 3, 6, and 7 could be associated with Web server 210 using device option (4).

Device option (3) is a static assignment of requests to resources, done in the definition of the workload, and with no possibility of rescheduling at evaluation time. An example of this would be when there is only a single resource of a particular type available in the system, and hence there is no need to choose from amongst multiple instances of a resource.

One exemplary input to the workload generator 100 is represented by statistical data 108. The statistical data 108 provides a stochastic model of requests that a simulated application would expect to process over a period of operation. Requests generally refer to messages received by the application from another system resources. Requests may include without limitation requests that the application perform a specified function, inquiries for data accessible by the application, acknowledgments from other resources, and messages providing information to the application. For example, by monitoring the requests processed by a comparable application, a developer may determine that the simulated application would expect to receive: (1) requests to view the home page [20%]; (2) requests to add an item to a shopping cart [17%]; (3) requests to search the web site [35%]; and (4) requests to view a product [28%]. Many other requests may be also represented within the statistical data 108.

A developer may augment the raw monitored statistical results with new requests supported in the simulated application (e.g., new features) that were not available in the monitored software system. In addition, the developer may augment the monitored statistical results with changes that the developer anticipates with the new software system. For example, a higher percentage of search requests may be expected in the new application, as compared to the monitored system, because of an improved design of the new application. Therefore, the developer may increase the percentage of search requests expected in the new application and decrease the expected percentage of other requests, or vice versa. Accordingly, based on the monitored stochastic model of a comparable software system and the alterations supplied by the developer, if any, the statistical data 108 provides a representative mix of the requests that the simulated software system should handle during a simulation, thereby approximating an anticipated request load for the simulated application.

Another exemplary input is represented by monitoring traces 110, which are typically rendered by monitoring tools observing the operation of a comparable software system under an exemplary load. In contrast to the statistical data 108, which specifies the statistical profile of requests processed by the application being developed, the monitoring traces 110 represent the sequences of other requests related to (e.g., caused by or resulting in) the requests processed by the application.

For example, an application may experience requests for database queries received via the Internet, which occur 20% of the time. Each such request results from a client request transmitted through the Internet and a router to a web server on which the application is running. In response to receipt of each request, the application issues one or more requests to an SQL server coupled to the target database. The SQL server subsequently responds to the application with the result of the query. The application then transmits the query result via the router and the Internet to the client. As such, with each type of request processed by an application, there exists a sequence of related requests processed by various resources in the software system. In an embodiment of the present invention, this sequence of related requests is defined in the monitoring traces 110. The level of abstraction or specificity represented by the requests in a monitoring trace may be dependent on various factors, including without limitation the needs of the developer, the precision of the monitoring tool, and the sophistication of the hardware models.

Another exemplary input is represented by a workload specification 112, which may be recorded in a performance specification language (PSL) or a wide variety of other means. PSLs enable users to specify performance characteristics of a particular system of interest. For example, PSLs may be employed in the design stage of software development to prototype the performance characteristics of an application. A PSL may also be used in later stages of software development to experiment with new software designs and resource configurations. For example, a software developer can create a PSL model of a software system, including the application of interest as well as other resources (e.g., other applications such as an SQL server application; software components such as process threads; and hardware resources such as a client system, a router, a storage disk, or a communication channel).

The workload specification 112 comprises a set of hardware or virtual device usage request descriptions (i.e., resource usage request descriptions). Collectively, hardware devices and virtual devices are referred to as “resources”. Hardware devices represent system components such as a CPU (central processing unit), a communications network, a storage medium, and a router. Virtual devices represent computer resources that are not associated with a particular tangible hardware device, including a software library, a socket communication port, a process thread, and an application. For example, a virtual device may represent a thread of control on a network interface card (NIC) responsible for moving data to and from a network.

A resource usage request description may identify various characteristics of a workload request, including a request identifier, an identified source device hardware model type, an identified target device hardware model type, and a workload configuration. The identified hardware models are subsequently used during the evaluation stage to translate the workload requests into component events and to calculate the delay associated with the identified resource usage request.

In summary, the monitoring traces 110 define the request sequences associated with a given transaction. The statistical data 108 defines the frequency of a given transaction during normal operation conditions. The workload specification 112 defines each request supported in the software system. These inputs may be processed by the workload generator 100 to produce one or more workload definition sequences 120.

The evaluation engine 104 inputs the workload definition sequence 102 and simulates the software system defined therein using one or more hardware models 118 to produce the simulation results 106. The evaluation engine 104 may also process multiple workload definition sequences concurrently. During evaluation, the evaluation engine 104 activates one or more of the workload definition sequences 120 based on a predetermined condition. In one embodiment, the predetermined condition is the start time recorded in association with a start node of the sequence, although other conditions are contemplated within the scope of the present invention, such as the occurrence of specified event derived from another workload definition sequence or an external signal (e.g., from another evaluation engine).

Each workload request node in a workload definition sequence comprises one or more component events. For example, a request from a web server for an SQL (structured query language) query to an SQL server may comprise several exemplary internal events, such as (a) transmitting the request from the web server to the SQL server; (b) communicating the request over a local area network; and (c) receiving the query request at the SQL server; (c) executing the query request in the database. Rather than model each of these events as a separate request node within a workload definition sequence, the SQL request node may be modeled as a single request node having multiple component events known to the hardware model representing the web server, the network, or the SQL server. Therefore, SQL request is translated into the set of component events using the appropriate hardware model before simulation. The level of abstraction or specificity represented by a request node may be dependent on various factors, including without limitation the needs of the developer and the sophistication of the hardware models. The performance simulation infrastructure is flexible enough to accommodate a wide variation in the level of modeling precision.

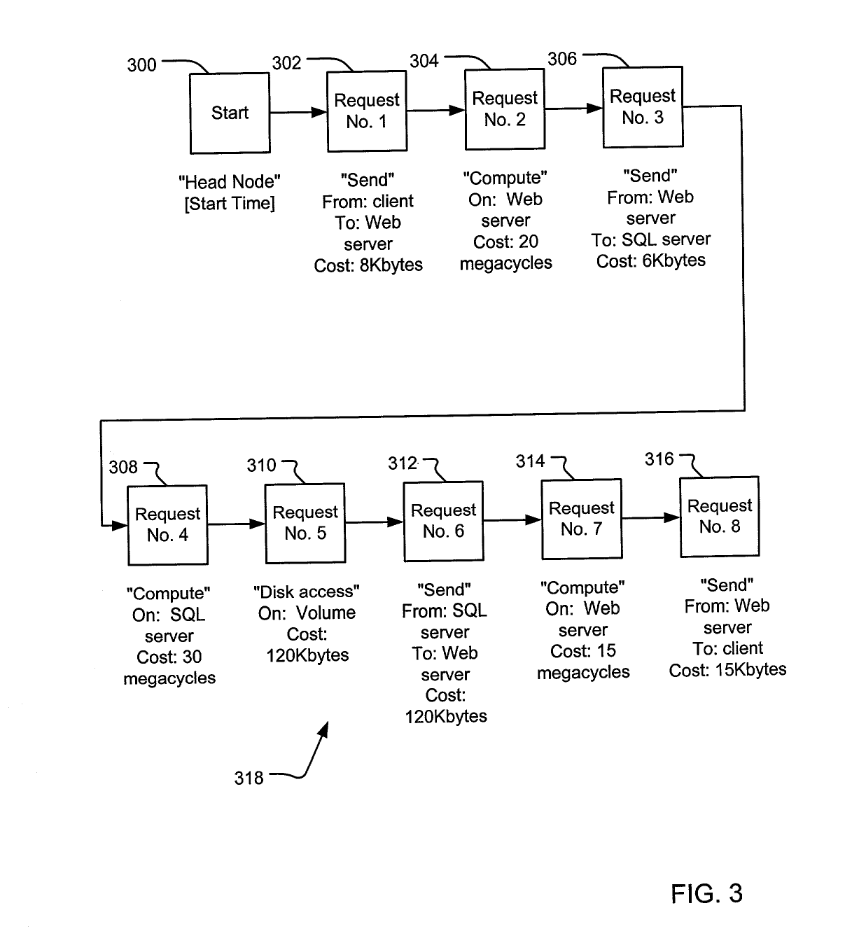

FIG. 2 illustrates an exemplary sequence of requests associated with a query request to an application in an embodiment of the present invention. The individual requests defined for this example are depicted by the arrows labeled by a number in a circle, wherein the circled number represents a request's ordered position in the sequence of requests. FIG. 3 illustrates nodes in a representation of an exemplary workload definition sequence associated with the requests depicted in FIG. 2.

It should be understood that a workload definition may be generated to define an arbitration number of resources in the software system, with varying levels of abstraction. For example, process threads and individual CPUs within each of the computing resources may be modeled, whereas in this example, only the server systems are modeled. However, each request may be broken down into “component events”, which may consider individual process threads, CPU's, communication channels, etc.

The resource configuration illustrated in FIG. 2 includes various hardware devices and virtual devices. A client 200 represents a client computer system coupled to one of the web servers 206-210 via a communications network 202, such as the Internet, and a router 204. In a common scenario, the client 200 executes a browser through which a consumer accesses a vendor's on-line catalog. The exemplary Request No. 1 represents an inquiry about a product, possibly invoked by the consumer clicking an on-screen button or hypertext link. The request is directed to a given web site, provided by one of a plurality of web servers, which are shown as Web servers 206-210 and which may be embodied by IIS s (Internet Information Server) or other Web server systems. In response to such consumer input, the Request No. 1 is transmitted through the network 202 and a router 204 to one of the Web servers 206-210.

The router 204 has multiple destination options. That is, the router 204 may route the Request No. 1 to any one of the multiple Web servers 206-210, which are running the server application that is being simulated. The selection of which Web server processes the request from the router may be controlled by a scheduling policy during simulation.

A Request No. 2 represents computations by the selected Web server 210, responsive to the Request No. 1. A Request No. 3 represents an SQL query generated by the Web server 210 to the SQL server 212. A Request No. 4 represents computations by the SQL server 212 in processing the SQL query of the Request No. 3, which results in a Request No. 5 representing a storage access to a logical volume 214 that stores a database. A Request No. 6 represents a response to the SQL query, transmitted from the SQL server 212 to the same Web server 210 that generated the Request No. 3. A Request No. 7 represents computations by the Web server 210 processing the results of the SQL query received from the SQL server 212 and generating a Request No. 8 for transmission to the client 200.

Each of these requests is defined in an exemplary workload definition sequence (see FIG. 3), which is generated by a workload generator. The workload definition sequence is then processed by an evaluation engine to accomplish the desired performance simulation of the system workload.

FIG. 3 illustrates nodes in a representation of an exemplary workload definition sequence 318 associated with the requests depicted in FIG. 2 in an embodiment of the present invention. By defining the workload as a sequence of workload request nodes, the workload may be defined completely in a first stage of the performance simulation and then be evaluated in an independent second stage of the performance simulation, without looping back to the workload generator after every simulation interval for the next workload state to be generated. As such, the sequence of workload states is already generated and defined in the workload definition sequence. Each request node may also be associated with parameters defining characteristics of the node in the workload sequence.

A node 300 represents a start node or head node, as described with regard to the workload definition sequences 120 in FIG. 1. A “start time” of the workload definition sequence is recorded as a parameter in association with the node 300. The start time is employed by the evaluation engine to start a given workload definition sequence during the simulation. Because multiple workload sequences may be active in any given simulation interval, the start time allows the evaluation to start the active sequences at predefined and potentially different times, in accordance with a simulation clock. It should be understood that other methods of starting workload sequences in the simulation stage may also be employed within the scope of the present invention.

A node 302 represents a workload request node, which can represent a type of request within the software system. workload request nodes are described with regard to the workload definition sequences 120 in FIG. 1. The node 302 is designated as a “send” request corresponding to Request No. 1 in FIG. 2, being communicated from the client to the Web server. Furthermore, other parameters may also be associated with the node 302, such as the bandwidth or storage cost of the request, which is shown as 8 kilobytes. A scheduler in the evaluation engine determines (e.g., based on a scheduling policy) which Web server receives the request. Device option (2) may also be designated to ensure that the response to the SQL query be return to the client via the same Web server.

A node 304 represents a workload request node that is designated as a “compute” request corresponding to Request No. 2 in FIG. 2. The compute request is designated to generate an SQL query from one of the Web servers in the software system and is associated with a computational cost of 20 megacycles. Device option (4) may be designated to ensure that the same Web server that received the Request No. 1 also processes the Request No. 2.

A node 306 represents a workload request node that is designated as a “send” request corresponding to Request No. 3 in FIG. 3. The send request is designated to be communicated from the Web server that processed the Request No. 2 to an SQL server. The cost of the requests is designated as 6 kilobytes.

A node 308 represents a workload request node that is designated as a “compute” request corresponding to Request No. 4 in FIG. 2. The compute request is designated to process the SQL query on an SQL server in the software system and is associated with a computational cost of 30 megacycles.

A node 310 represents a workload request node that is designated as a “disk access” request corresponding to Request No. 5 in FIG. 2. The disk access request is designated to perform a storage access on a logical volume to satisfy the SQL query, with a cost of two disk accesses. Device option (4) may be designated to ensure that the same Web server that received the Request No. 1 also processes the Request No. 6.

A node 312 represents a workload request node that is designated as a “send” request corresponding to Request No. 5 in FIG. 3. The send request is designated to be communicated from the SQL server that processed the Request No. 4 to the Web server that processed Request No. 3. The cost of the requests is designated as 120 kilobytes. Device option (4) may be designated to ensure that the same Web server that received the Request No. 1 also processes the Request No. 7.

A node 314 represents a workload request node that is designated as a “compute” request corresponding to Request No. 7 in FIG. 2. The compute request is designated to process the SQL query result on the Web server in the software system that processed Request No. 3 and is associated with a computational cost of 15 megacycles.

A node 316 represents a workload request node designated as a “send” request corresponding to Request No. 1 in FIG. 2, being communicated from the Web server to the client. The send request is designated to communicate the SQL query result or data derived therefrom to the client. The cost of the requests is designated as 120 kilobytes.

FIG. 4 illustrates an evaluation engine for simulating performance of a software system in an embodiment of the present invention. An activator module 404 of the evaluation engine 400 receives one or more workload definition sequences 402 as input. In one embodiment, the activator module 404 triggers the activation of a workload definition sequence 402 based on a clock 406 and a time stamp or start time (not shown) recorded in association with the start node of the sequence. When the clock 406 reaches the time indicated by the start time of a given workload definition sequence 402, the activator module 404 passes the workload definition sequence 402 into a set of active workload sequences 408 for the evaluation engine 400 to simulate.

The active workload sequences 408 are accessible by a sequence processor 410, which at each simulation interval evaluates the active sequences 408 for one or more workload request nodes that are to be processed in the next simulation interval. For example, after a workload definition sequence is activated by the activator module 404 and passed into the set of active sequences 408, the sequence processor 410, prior to the next simulation interval, determines that the new active sequence has a workload request node that is ready to be processed (because it has been newly activated based on its start time). The sequences processor 410 also processes a workload request node of an active sequence upon completion of the simulation of the previous workload request in the active sequence, as discussed below.

The sequence processor 410 has access to a list of possible target devices (also referred to as “resources”) in the software system and their associated hardware models. The resources are represented within the evaluation engine 400 by hardware models 416. Having identified workload request nodes of active sequences 408 that are to be simulated in the next simulation interval, the sequence processor 410 identifies the system resources associated with each pending request node and calls the hardware models corresponding to the identified resources to translate each request node into component events. A list of available resources is given to the sequence processor in a “topology script”, which may be encoded as an XML file, for example. The topology script defines the numbers of, types of, and relationships among the devices in the software system being modeled.

For example, Request No. 1 in FIG. 2 involves a client computer, the network, the router, and one of the web servers. A hardware model for each resource will assist in translating the request node into its component events. An exemplary communication request may be translated into two component events, one for the sender and one for the sender, representing the endpoints of the communication request. Disk and CPU requests may be translated into single component events, representing disk seeks and blocks of computational time, respectively.

The sequence processor 410 causes the events corresponding to the identified workload request nodes to be passed into an event queue 412. The events in the event queue 412 are input to a scheduler module 414, which is responsible for assigning the events to individual event lists associated with instances of the hardware models, based on current load and system scheduling policies.

The scheduler module 414 has access to a scheduling policy for assigning events to available resources. In various embodiments, exemplary scheduling policies (such as those listed below) are used to assign events to available resources. Each event may be associated with a type of resource or with a specific resource that is to process the event. For example, a request received over the Internet through a router may target any number of web servers coupled to the router; therefore, component events may be scheduled with one of the relevant web servers in the software system. The scheduler module 414 uses the scheduling policy to designate the web server to which the event is assigned. Alternatively, in a simpler circumstance (when only one possible resource is available to process an event), the event may be directed to a single resource, such as a specific SQL server. As such, the scheduling policy may be bypassed, and the event is assigned to that specific SQL server for simulation (e.g., using device option (3)).

Exemplary scheduling policies may include, without limitation:

(1) First Free/Random—(a) Assign the request to the first available resource; (b) if none are available, select any non-available resource at random;

(2) First Free/Round-Robin—(a) Assigned the request to the first available resource; (b) if none are available, select from the non-available resource in a round-robin pattern;

(3) Random—select any resource at random; and

(4) Round-robin—select any resource according to a round-robin pattern.

Using the list of possible target devices and the scheduling policy, the scheduler module 414 assigns an event to a specific target resource (i.e., represented by an instance of a hardware model), whether or not that target resource is currently available to process the event. For example, a web server may not be able to immediately (i.e., in the current simulator interval) service a new web request because the hardware model representing the web server has not yet completed a previously web request. Assignment of an event to a target resource may involve passing the event into a event list dedicated to the specific hardware model and assigning a hardware model identifier to the event so that it may be passed to the appropriate hardware model when the target resource is available, as well as other methods of assigning an event to a target resource.

In a simulation interval, the simulator module 418 simulates the pending events using an instance of a hardware model. In an embodiment of the present invention, the simulator module 418 calls the instance of the hardware model 416 representing the target resource of an event to determine the duration of the event. The simulator module 418 may simulate multiple events concurrently, with the clock 406 advancing to the completion time of at least one of the events. The completed event or events are removed from the event list.

In addition, if the completed event is the last event associated with a request node of a active sequence, the completion of the event in a given simulation interval can result in the sequence processor 410 evaluating that active sequence to determine the next available request node in that sequence. Completion of the last event associated with a request node may result in issuance of a completion signal, which causes the sequence processor 410 to translate the next request node in that active sequence into its component events and to pass the events to the event queue 412. That is, if the simulation of an event results in the completion of all of the component events of a request node of a given active sequence, the sequence processor 410 re-evaluates the active sequence to identify the next request node in that active sequence. Having identified the next request node, the sequence processor 410 processes the request node, translating it into its component events, and passes the events to the event list.

In contrast, an active sequence that has already started its simulation may not yet be ready for incrementing to the next workload request node (e.g., because the currently simulating request node has remaining component events that require simulation—the simulation of the request node is not yet complete). In this circumstance, the sequence processor 410 does not pass the next workload request node for the active sequence to the event queue 412 for simulation. In one embodiment, the determination of the next request node of an active sequence is conditional on a “completion” signal or rule associated with a simulated workload request node of the active sequence.

In an embodiment of the present invention, the clock 406 advances at discrete intervals, each interval being determined based on the minimum completion time of an event in the simulation or the next start time for a new active sequence, whichever is sooner. If the clock 406 increments to a time that satisfies the start time of a workload definition sequence received by the evaluation engine, the activator module 404 will activate the sequence and the sequence processor 410 will process the first request node into events. Also, if multiple events are simulated concurrently by the simulator module 418 during the same simulation interval, the clock 406 increments to the time at which the first event completes (based on the predicted duration of the event). If the completed event also completes a request node, then the sequence processor 410 initiates the next request node in the same sequence and the scheduler 414 schedules the events with the appropriate hardware model. After incrementing the clock 406, the simulator 418 starts the next simulation interval with any new or pending events designated for the current interval. Therefore, in addition to being used in activating sequences, the clock 406 may also be used as a basis for simulating each event and incrementing to the next set of workload request nodes to be simulated.

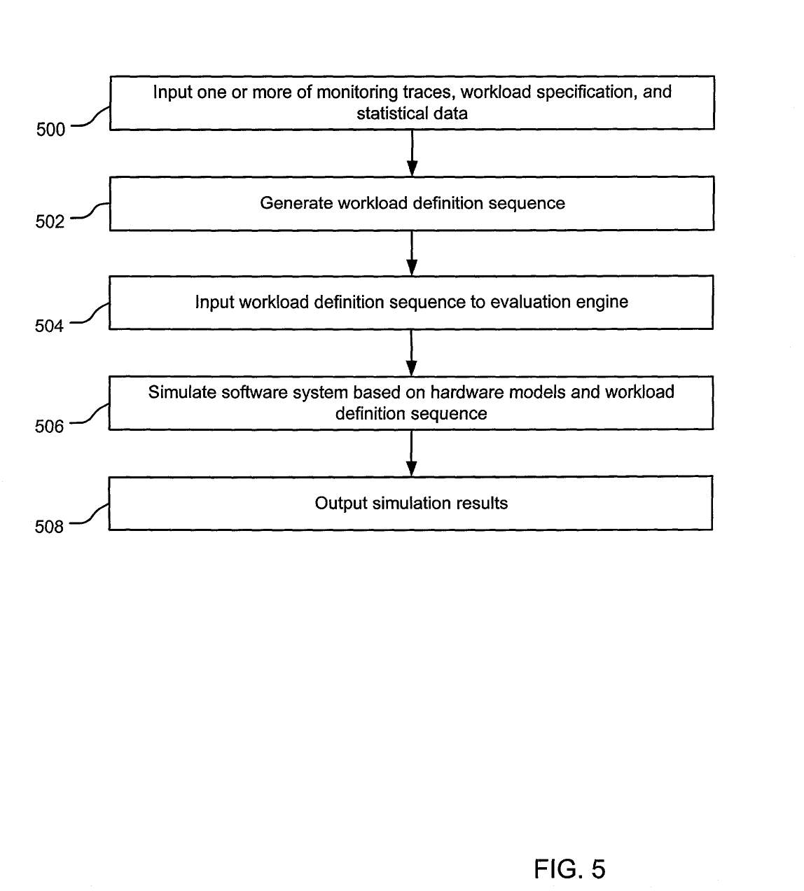

FIG. 5 illustrates operations for performing a performance simulation in an embodiment of the present invention. Operation 500 inputs one or more of monitoring traces, workload specifications, and statistical data, as discussed with regard to FIG. 1. Operation 502 generates a workload definition sequence according to the input data received in operation 500.

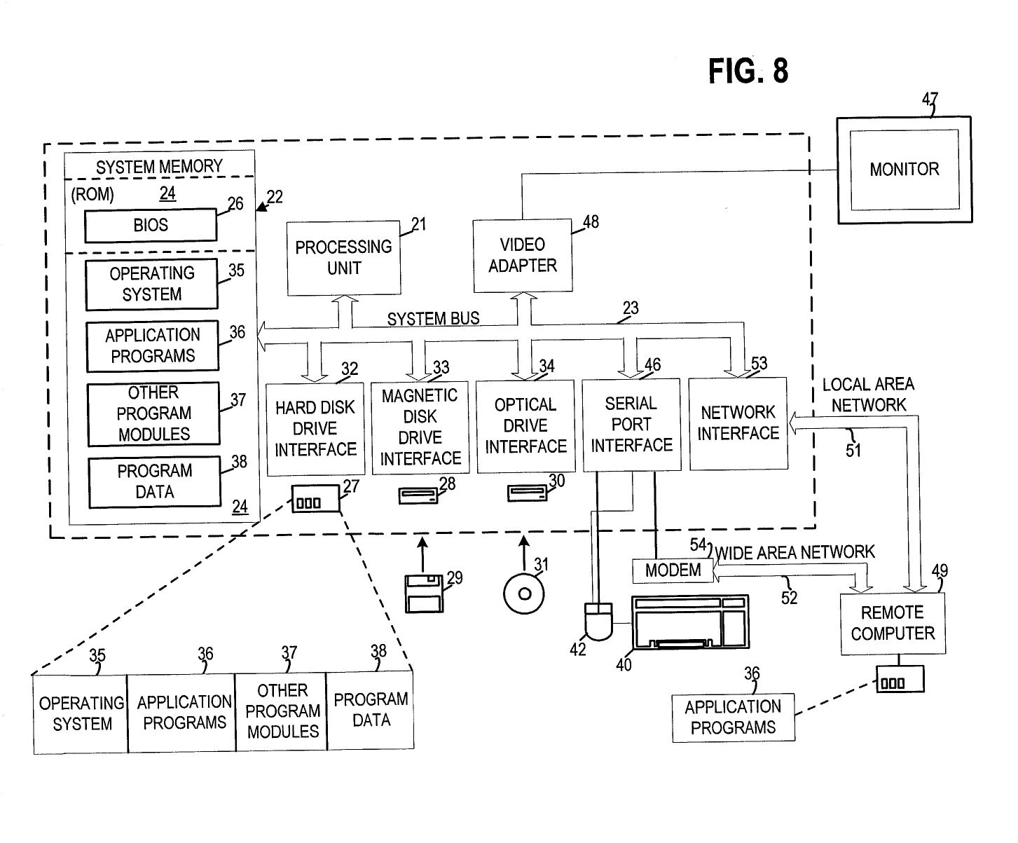

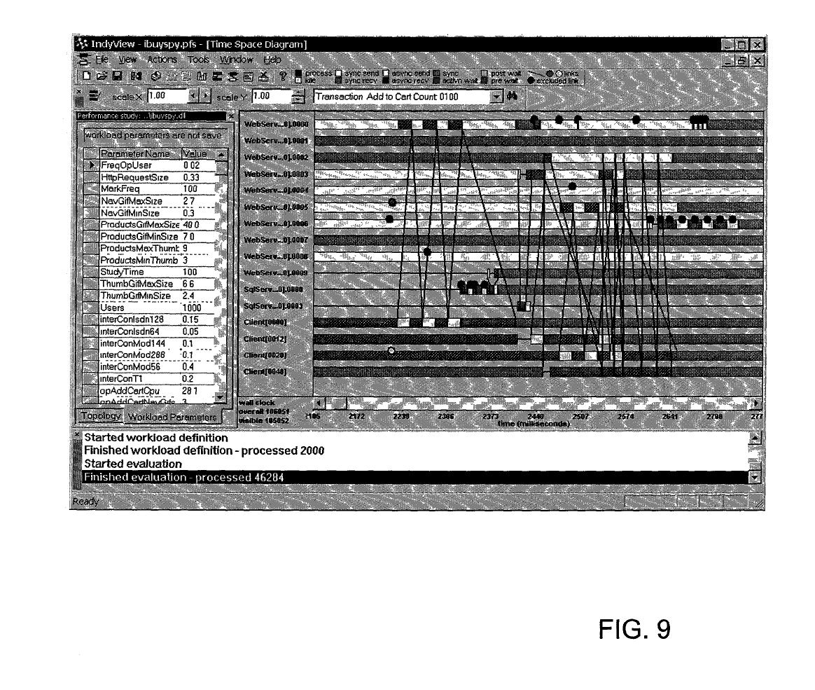

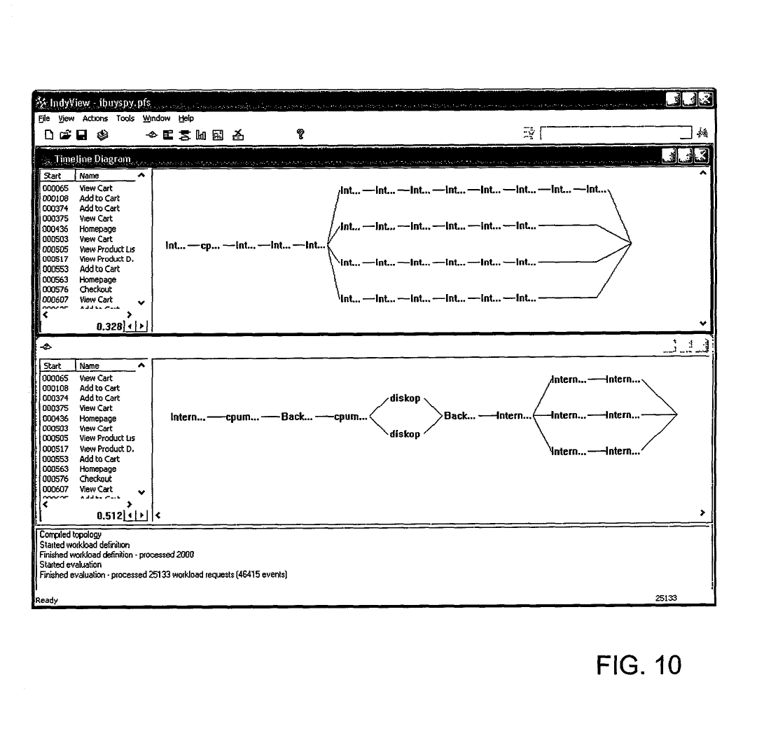

Operation 504 inputs one or more workload definition sequences to the evaluation engine. Operation 506 simulates the software system based on the workload definition sequence or sequences that are input to the evaluation engine as well as hardware models accessible to the evaluation engine. The operation 506 can simulate multiple simulation intervals, multiple requests, and multiple workload definition sequences without requiring the evaluation engine to loop back to the workload definition generator for generation of a new workload state. Operation 508 outputs the simulation results, such as into a file, a database, a printout or a display device. An exemplary display of simulation results is shown in FIG. 8.

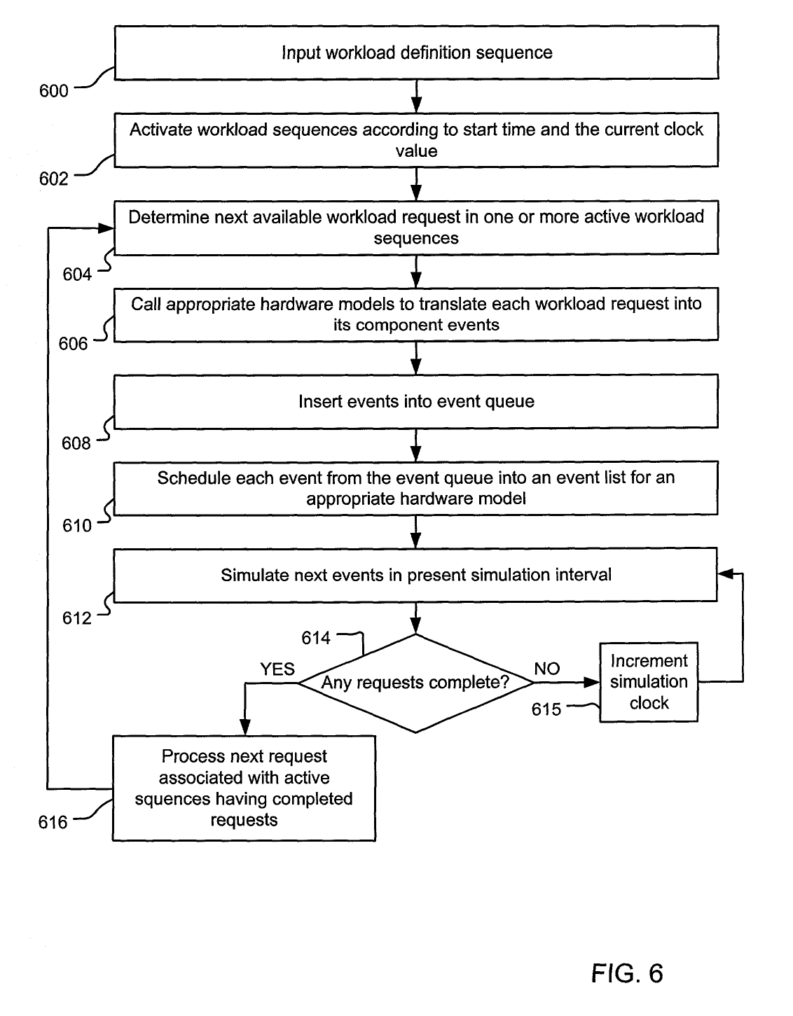

FIG. 6 illustrates operations for evaluating a software system in an embodiment of the present invention. An inputting operation 600 inputs one or more workload definition sequences into the evaluation engine. An activation operation 602 activates workload sequences according to the start time and the current clock value. For example, if the simulation clock (e.g., clock 124 in FIG. 1) reaches a time interval satisfying the start time associated with a start node of a workload definition sequence, the sequence is added to the set of active sequences. It should be understood that this operation is independent of clocking employed in the workload definition stage (e.g., via clock 122). That is, the simulation intervals in the evaluation engine are asynchronous with regard to clocking in the workload definition stage.

A determining operation 604 determines the next available workload request (i.e., request node) for each active sequence. Accordingly, the determining operation 604 identifies those request nodes that are to be processed in the next simulation interval. One type of request node that may be identified and processed is the request node following a start node that has just been added to the set of active sequences. Alternatively, other requests nodes may have been previously processed to a “completed” state (e.g., by operation 612).

A completed request refers to a request node for which all of the relevant component events have been simulated. In decision operation 614, completion of the simulation of such a request is determined after the last event has been simulated for the request. If completion of a request is determined in decision operation 614, a processing operation 616 indicates that the request has been completed and determining operation 604 determines the next available request, if any, for that workload sequence. If decision block 614 determines that no request is complete, clocking operation 615 increments the simulation clock to the minimum event interval and proceeds to a simulation operation 612, which continues to simulate any pending events and starts simulating any new events for active sequence (e.g., events associated with newly activated and scheduled requests as well as the next event following the completed event).

It should be understood, however, that simulation of some request nodes may complete in any given simulation interval while simulation of other request nodes may not. As such, the processing paths through operations 615 and 616 may execute concurrently for different active sequences. Accordingly, for some active sequences, events for new request nodes are scheduled and added to the event list for simulation while events for other requests nodes may still be pending.

In an embodiment of the present invention, a translation operation 606 calls the appropriate hardware models associated with each next workload request node to translate each request into its one or more component events. The number and type of component events depend on the particular hardware model and type of workload request. For example, the hardware model handling a communication operation request will generate two component events, one for the source of the communication and one for the destination. The events generated for each “next workload request” are then inserted into the appropriate event queues by the insertion operation 608. The translated events for each “next workload request” are inserted into an event queue by insertion operation 608.

A scheduling operation 610 schedules events from the event queue with appropriate instances of hardware models configured for the software system. For some events, scheduling involves selecting for each event a specific instance of the appropriate type of hardware model in the resource configuration, such as a CPU, a communications channel, or a hard disk. For other events, scheduling involves selecting one of a plurality of appropriate hardware model instances that may be scheduled for a given event in accordance with a scheduling policy. For example, the router may pass an SQL request from a client to one of several Web servers in FIG. 2. Which Web server that is actually scheduled by the scheduler to process the request (e.g., the events of receiving, processing, and generating a response) may be determined in accordance with a scheduling policy or an algorithm built into the router hardware model. The simulation operation 612 performs the simulation of each event scheduled for a given simulation interval, based on the appropriate workload parameters and hardware models associated with the event.

Programming interfaces for implementing an embodiment of the presentation are listed below, although it should be understood that wide variations in the interface are contemplated within the scope of the present invention.

TMLNCHRONO Class

An instance of the TMLNCHRONO class contains all of the sequences for a particular performance study and is implemented as an array sorted by activation (start) times.

Methods

| | |
|---|---|
| tmlnchrono() | Create timeline chronology |
| insert(timeline) | Insert timeline |
| sort() | Sort timelines using timeline activation time as key |
| size() | Return registered timelines |

Specification of a TMLNCHRONO class

TIMELINE Class

An instance of the TIMELINE class represents a sequence of workload requests. Such an instance is produced by the workload generator, and consumed by the evaluation engine. A section of timeline is called a branch—there may be multiple branches (e.g., sequence portions) due to fork operations. Likewise, multiple branches may be combined by a join node.

Methods

Given the name of the timeline, its activation time, and a reference to a new TLBRANCH structure (see below), an instance of the TIMELINE class creates and returns a timeline data structure, and fills in the TLBRANCH structure to represent the current branch. timeline (name, time, tlbranch)

Methods to fork, rejoin, and tag tlbranches generated from a timeline:

fork(count)

join(tlbranch[ ])

tag(tlbranch,name)

Specification of a TIMELINE class

TLBRANCH Class

An instance of the tlbranch class represents a single branch of a timeline and is used within the workload generator to represent the current branch being created.

Methods

Methods to define a workload request (represented by a parvalarr, a generic array of values) and add it to a tlbranch. Workload requests are named, and may be scheduled using either a scheduling algorithm, a reference to a previously-generated schedule, or a static schedule (event list).

def(scheduler,name,parvalarr)

def(scheduler_ref name,parval_arr)

def(evlist,name,parval_arr)

Methods to set the peer (target) of communication workload requests:

peer(scheduler,peemum)

peer(scheduler_ref,peemum)

peer(evlist,peemum)

Methods to set, cancel, and get filter functions for extended output and markers. These filter functions are applied to every workload request as they are added to a tlbranch. They can be used to e.g. mark every 100th workload request for later analysis.

def FilterXoutput(filter), def_CancelXoutput( ), def GetXoutput( )

def FilterMarker(filter), def_CancelMarker( ), def GetMarker( )

Specification of a TLBRANCH class

TIMELINE IT Class

An instance of the TIMELINE_IT class represents an iterator over a TIMELINE or TLBRANCH and is used to simplify access to the individual actions (e.g., such an instance abstracts away from the particular data type used to represent a TIMELINE or TLBRANCH). An instance of the TIMELINE_IT class supports standard C++ iterator methods.

Methods

First( )

Next( )

GetNode( )

Specification of a TIMELINE_IT class

SCHEDULE Class

An instance of the SCHEDULE class represents a dynamic scheduler assigned to a particular class of devices.

Methods

| | |
|---|---|
| schedule(pattern, policy) | Creates a scheduler based on a policy and |
| | a text pattern that matches device names. |
| schedule(evlist_arr, policy) | Creates a scheduler based on a policy and |
| | an array of event lists representing the |
| | devices. |
| Go() | Runs the scheduler, chooses one of the |
| | devices, and returns a pointer to its event list. |
| GetReference() | Return a reference to a scheduler |

Specification of a SCHEDULE class

SCHEDPOLICY Class

The SCHEDPOLICY class is an abstract class representing a generic scheduling policy and is specialized to implement a particular policy. Example policies include:

| | |
|---|---|
| Random | Choose device at random |
| RoundRobin | Choose device in round-robin order |
| FreeRandom | Choose first free device, or at random if none free |
| FreeRoundRobin | Choose first free device, or in round-robin order |
| Methods: | |
| Create() | Create scheduler |
| Config() | Configure (initialize) scheduler |
| Schedule() | Select device |

Specification of a SCHEDPOLICY class

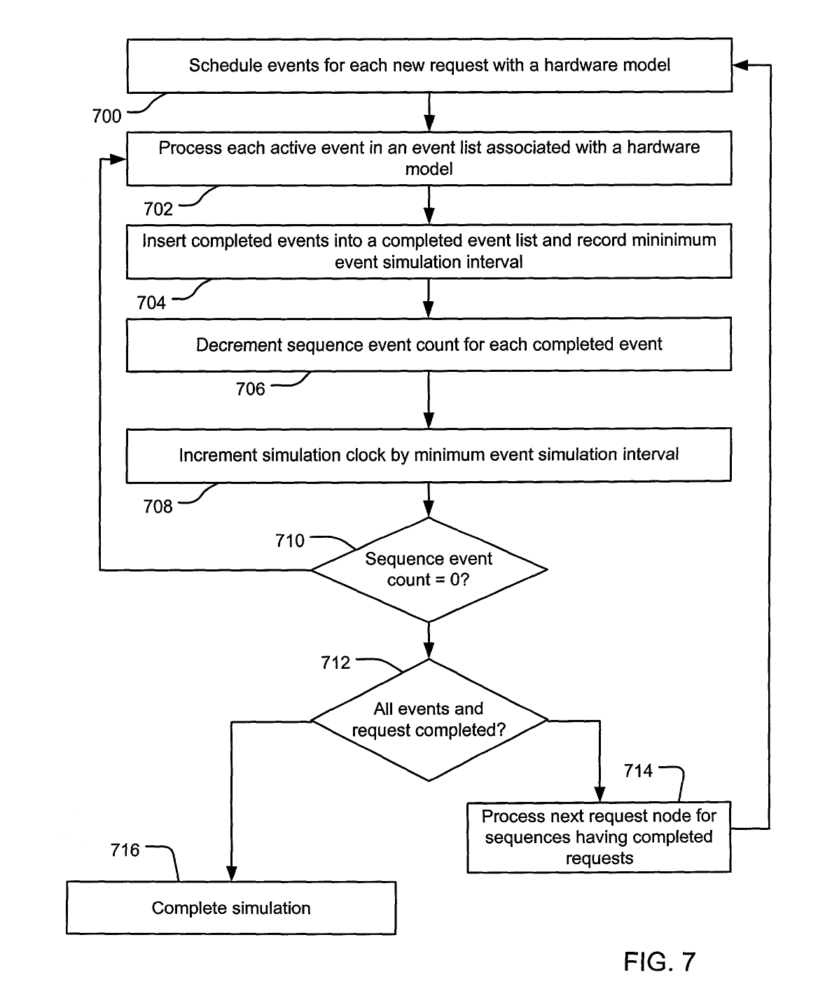

The exemplary hardware and operating environment of FIG. 7 for implementing the invention includes a general purpose computing device in the form of a computer 20, including a processing unit 21, a system memory 22, and a system bus 23 that operatively couples various system components include the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 1. The logical connections depicted in FIG. 1 include a local-area network (LAN) 51 and a wide-area network (WAN) 52. Such networking environments are commonplace in office networks, enterprise-wide computer networks, intranets and the Internal, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internal. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

In an embodiment of the present invention, a workload generator and/or an evaluation engine that performs late-binding of resource allocation in performance prediction software may be incorporated as part of the operating system 35, application programs 36, or other program modules 37. The input data, workload definition sequences and simulation results associated with such a performance prediction software may be stored as program data 38.

The embodiments of the invention described herein are implemented as logical steps in one or more computer systems. The logical operations of the present invention are implemented (1) as a sequence of processor-implemented steps executing in one or more computer systems and (2) as interconnected machine modules within one or more computer systems. The implementation is a matter of choice, dependent on the performance requirements of the computer system implementing the invention. Accordingly, the logical operations making up the embodiments of the invention described herein are referred to variously as operations, steps, objects, or modules.

The above specification, examples and data provide a complete description of the structure and use of exemplary embodiments of the invention. Since many embodiments of the invention can be made without departing from the spirit and scope of the invention, the invention resides in the claims hereinafter appended.

What is claimed is:

1. A computer program product encoding a computer program for executing on a computer system a computer process for simulating performance of a software system including one or more resources, the computer process comprising:
generating one or more workload definition sequences defining the software system, each workload definition sequence including a plurality of workload request nodes, the workload definition sequence including at least two of the workload request nodes having a sequential relationship relative to different simulation intervals;
receiving the workload definition sequence into an evaluation engine; and
evaluating the one or more workload definition sequences to simulate the performance of the software system.

2. The computer program product of claim 1 wherein each request node is defined independently of a specific hardware model instance.

3. The computer program product of claim 1 wherein each workload request node defines a transaction associated with a resource in the software system.

4. The computer program product of claim 1 wherein each workload request node represents one or more component events associated with a resource in the software system,

5. The computer program product of claim 1 wherein the one or more workload sequences are generated prior to the receiving and evaluating operations and substantially define all workload request nodes for simulating performance of the software system.

6. The computer program product of claim 1 wherein each workload request node defines a device option characterizing constraints on how the workload request node may be assigned to a resource in the software system.

7. The computer program product of claim 1 wherein at least one workload sequence includes a fork node defining a split of one workload sequence branch into a plurality of w workload sequence branches.

8. The computer program product of claim 1 wherein at least one workload sequence includes a join node defining a combination of a plurality of workload sequence branches into a single workload sequence branch.

9. The computer program product of claim 1 wherein the computer process further comprises:
receiving at least one of a monitoring trace, statistical data, and a workload specification to generate the one or more workload definition sequences.

10. The computer program product of claim 1 wherein the operation of receiving at least one of a monitoring trace, statistical data, and a workload specification comprises:
receiving the monitoring trace defining a sequence of software system requests relating to an application request associated with the application.

11. The computer program product of claim 1 wherein the operation of receiving at least one of a monitoring trace, statistical data, and a workload specification comprises:
receiving the statistical data defining a statistical distribution of one or more application requests associated with the application.

12. The computer program product of claim 1 wherein the operation of receiving at least one of a monitoring trace, statistical data, and a workload specification comprises:
receiving the workload specification defining a set of resource request descriptions associated with the software system.

13. The computer program product of claim 1 wherein each workload definition sequence comprises a start node associated with a start time, and the simulating operation comprises:
activating at least one of the workload definition sequences, if the start time associated with the start node of the workload definition sequence satisfies the simulation interval value.

14. The computer program product of claim 1 wherein the simulation operation comprises:
translating at least one of the workload request nodes into one or more component events recorded in an event queue.

15. The computer program product of claim 14 wherein the evaluating operation comprises:
scheduling each component event with an instance of a hardware model associated with a resource in the software system.

16. The computer program product of claim 14 wherein the evaluating operation comprises:
scheduling, based on a scheduling policy, each component event with an instance of a hardware model associated with a resource in the software system.

17. The computer program product of claim 14 where the evaluating operation further comprises:
receiving one of the component events from the event queue;
identifying a resource associated with the component event;
scheduling the component event with an instance of a hardware model associated with the resource in the software system; and
simulating the component event using the instance of the hardware model.

18. A performance simulation system for simulating performance of a software system, the performance simulation system comprising:
a workload generator generating one or more workload definition sequences defining the software system, each workload definition sequence including a plurality of workload request nodes, the workload definition sequence including at least two of the workload request nodes having a sequential relationship relative to different simulation intervals; and
an evaluation engine receiving the one or more workload simulation sequences and evaluating the one or more workload definition sequences to simulate the performance of the software system.

19. The performance simulation system of claim 18 wherein each workload request node defines a transaction associated with a resource in the software system.

20. The performance simulation system of claim 18 wherein each workload request node represents one or more component events associated with a resource in the software system.

21. The performance simulation system of claim 18 wherein each workload request node defines a device option characterizing constraints on how the workload request node may be assigned to a resource in the software system.

22. The performance simulation system of claim 18 wherein at least one workload sequence includes a fork node defining a split of one workload sequence branch into a plurality of workload sequence branches.

23. The performance simulation system of claim 18 wherein at least one workload sequence includes a join node defining a combination of a plurality of workload sequence branches into a single workload sequence branch.

24. The performance simulation system of claim 18 wherein each workload definition sequence comprises a start node associated with a start time, and the evaluation engine comprises:
a simulation clock incrementing a simulation interval value; and
an activator activating one of the workload definition sequences, if the start time associated with the start node of the workload definition sequence satisfies the simulation interval value.

25. The performance simulation system of claim 18 wherein the evaluation engine comprises a sequence processor translating at least one of the workload request nodes into one or more component events.

26. The performance simulation system of claim 25 wherein the evaluation engine comprises:
an event queue receiving the component events from the sequence processor.

27. The performance simulation system of claim 25 wherein the evaluation engine further comprises a scheduler module assigning each component event to an instance of a hardware model representing a resource in the software system.

28. The performance simulation system of claim 27 wherein the scheduler module has access to a scheduling policy governing an assignment of a component event to an instance of a hardware model by the scheduler module.

29. The performance simulation system of claim 18 wherein the evaluation engine comprises a simulator determining a duration of a component event assigning to an instance of a hardware model.

30. A method of simulating performance of a software system including one or more resources, the method comprising:
generating one or more workload definition sequences defining the software system, each workload definition sequence including a plurality of workload request nodes, the workload definition sequence including at least two of the workload request nodes having a sequential relationship relative to different simulation intervals;
receiving the workload definition sequence into an evaluation engine; and
evaluating the one or more workload definition sequences to simulate the performance of the software system.

31. The method of claim 30 wherein each request node is defined independently of a specific hardware model instance.

32. The method of claim 30 wherein each workload request node defines a transaction associated with a resource in the software system.

33. The method of claim 30 wherein each workload request node represents one or more component events associated with a resource in the software system,

34. The method of claim 30 wherein the one or more workload sequences are generated prior to the receiving and evaluating operations and substantially define all workload request nodes for simulating performance of the software system.

35. The method of claim 30 wherein each workload definition sequence comprises a start node associated with a start time, and the simulating operation comprises:
activating at least one of the workload definition sequences, if the start time associated with the start node of the workload definition sequence satisfies the simulation interval value.

36. The method of claim 30 wherein the simulation operation comprises:
translating at least one of the workload request nodes into one or more component events recorded in an event queue.

37. The method of claim 36 wherein the evaluating operation comprises:
scheduling each component event with an instance of a hardware model associated with a resource in the software system.

38. The method of claim 36 wherein the evaluating operation comprises:
scheduling, based on a scheduling policy, each component event with an instance of a hardware model associated with a resource in the software system.

39. The method of claim 36 where the evaluating operation further comprises:
receiving one of the component events from the event queue;
identifying a resource associated with the component event;
scheduling the component event with an instance of a hardware model associated with the resource in the software system; and
simulating the component event using the instance of the hardware model.
